(19) United States
(12) Patent Application Publication
(10) Pub. No.: US 2015/0372273 A1
(43) Pub. Date: Dec. 24, 2015

(54) HYBRID NONWOVEN SEPARATOR HAVING INVERTED STRUCTURE

(71) Applicant: TOPTEC HNS CO., Ltd., Gumi-si Gyeonsangbuk-do (KR)

(72) Inventor: Hyang Doo LEE, Busan (KR)

(21) Appl. No.: 14/369,162

(22) PCT Filed: Feb. 18, 2013
(86) PCT No.: PCT/KR2013/001247

§ 371 Date: Jun. 26, 2014

(30) Foreign Application Priority Data
Feb. 6, 2013 (KR) 10-2013-0013255

(51) Int. Cl. H01M 2/16

(52) U.S. Cl. CPC H01M 2/1686; H01M 2/162

(57) ABSTRACT

A hybrid nonwoven separator having an inverted structure includes a nanofiber layer; and a substrate layer composed of a nonwoven fabric provided on both surfaces of the nanofiber layer to form an outermost layer. Because this separator is configured such that the substrate layer having a comparatively low coefficient of friction is disposed as the outermost layer thereof, structural defects generable in the course of manufacturing a separator can be prevented, thermal deformation of the nanofiber layer of the separator can be blocked, and also closure of pores of the nanofiber layer can be prevented thanks to pre-filtering, thus remarkably extending the lifespan of the separator.

### BACKGROUND

The present invention relates to a separator for use in a secondary battery, and more particularly, to a separator which is interposed between a cathode plate and an anode plate of a secondary battery so that only ions are selectively passed therethrough upon charging/discharging.

Secondary batteries, such as lithium ion secondary batteries, lithium polymer secondary batteries and super capacitors (electric double-layer capacitors and similar capacitors), are required to have high energy density, large capacity and thermal stability depending on the demand trends of high performance, lightness, and large scale for power sources for vehicles.

The currently widely available secondary battery is configured such that a separator is interposed between a cathode plate coated with a cathode active material and an anode plate coated with an anode active material, wound together, inserted into the case of the battery, and filled with an electrolyte, and then the case is sealed.

As such, the separator is known to have a structure in which a polymer material such as polyvinylidenefluoride (PVDF) is electrospun in the form of nanofibers on one or both surfaces of a nonwoven fabric layer composed of a polyethyleneterephthalate (PET) as a strength support layer to retain the necessary strength.

The structure of such a separator for a secondary battery is disclosed in Japanese Patent Application Publication No. 2006-92829 (published on Apr. 6, 2006), Korean Patent Application Publication No. 10-2006-0111842 (published on Oct. 30, 2006), etc., but the separator disclosed in the prior patents has the following problems.

First, the separator disclosed in the prior patents is configured such that the nanofiber layer is stacked on one or both surfaces of a PET substrate layer, and the nanofiber layer is much greater in specific surface area than the substrate layer, and thus exhibits very high frictional force with a heterogeneous material. Typically, the coefficient of friction of the PVDF nanofiber layer is known to be about 3-4 times larger than that of the PET substrate layer.

To fabricate a secondary battery, the cathode plate, the separator and the anode plate which are stacked together are wound using a mandrel. However, when the mandrel is removed in a wound state, the wound state is not maintained due to high coefficient of friction of the PVDF nanofiber layer of the separator, and thus the separator is removed along with the mandrel, undesirably causing serious structural problems upon fabrication of the secondary battery. Also, when the separator is automatically wound using a roll-to-roll device, the frictional force with the surface of the roll of a fabrication process line becomes strong due to large specific surface area of the nanofiber layer, and thus the accurate position of the separator cannot be found upon control of an EPC system, undesirably incurring serious damage such as wrinkling or tearing of the separator.

Second, as electrical oxidation and reduction are repeated in the course of continuous charging/discharging of a secondary battery, byproducts are generated. Such byproducts may close fine pores of the nanofiber layer, remarkably lowering the charging/discharging efficiency and considerably shortening the lifespan of the secondary battery. Furthermore, because of displacement of ions toward comparatively large pores instead of the closed pores, overheating occurs, undesirably melting of the separator to thus result in short-circuit.

Third, because the nanofiber layer is formed as the outermost layer of the separator in the above prior patents, the separator may shrink due to static electricity generated in the nanofiber layer, non-uniform swelling of the nanofiber layer by the electrolyte or an increase in temperature of the battery. Owing to a different coefficient of thermal expansion from the substrate layer, the nanofiber layer may be separated from the substrate layer.

Fourth, the nanofiber layer is lower in strength than the substrate layer, and is thus weak to external impact or scratching, making it impossible to ensure uniform quality of the separator.

### SUMMARY OF THE INVENTION

Accordingly, the present invention has been made keeping in mind the problems encountered in the related art, and an object of the present invention is to provide a separator for a secondary battery, which may solve problems due to high frictional force of a nanofiber layer stacked on or adhered to the separator and may ensure uniform structure and quality of the secondary battery.

Another object of the present invention is to provide a separator for a secondary battery, which enables pre-filtering so as to prevent performance of the separator from deteriorating due to byproducts and impurities generated upon charging/discharging of the secondary battery.

A further object of the present invention is to provide a separator for a secondary battery, which may have enhanced strength, thus preventing generation of structural defects due to impact or scratching, and has high heat resistance.

In order to accomplish the above objects, the present invention provides a separator having an inverted structure for a secondary battery, comprising a nanofiber layer; and a substrate layer comprising a nonwoven fabric provided on both surfaces of the nanofiber layer to form an outermost layer.

The nanofibers of the nanofiber layer may comprise a material selected from the group consisting of polyimide (PI), aramid, polyvinylidenefluoride (PVDF), polytetrafluoroethylene (PTFE), polychlorotrifluoroethylene (PCTFC), polyvinylidenefluoride-hexafluoropropylene (PVDF-HFP) and mixtures thereof.

The substrate layer preferably comprises polyethyleneterephthalate (PET).

Also, a hot melt layer comprising melted nanofibers for layer attachment may be further provided at an interface between the nanofiber layer and the substrate layer. In particular, the nanofiber layer may be provided in a multilayered form, and the hot melt layer comprising melted nanofibers for layer attachment may be further provided at an interface of the multilayered nanofiber layer.

Also, the substrate layer may comprise first PET fibers having a diameter ranging from 0.6 μm to less than 3.0 μm and a melting temperature of 240° C. or more and second PET fibers having a diameter ranging from 1.2 μm to less than 6.0 μm and a binder function at 100˜150° C.

As such, the substrate layer preferably has a porosity of 45˜85%, and an average pore diameter of 0.5˜7.0 μm.

Also, the substrate layer preferably has a punching strength of 200˜900 gf, and a tensile strength of 250˜1500 kgf/cm².

Herein, the use of the first PET fibers and the second PET fibers at a weight ratio of 30:70˜70:30 is particularly effective.

According to the present invention, a hybrid nonwoven separator having an inverted structure is configured such that a substrate layer is disposed at the outermost position of the separator, thus solving fabrication problems due to high frictional force generable in the course of fabrication of a secondary battery.

Also, the separator can maintain high heat resistance and strength, and the substrate layer thereof can function to primarily filter byproducts or impurities generated upon charging/discharging of the secondary battery, thus facilitating movement of ions, thereby increasing the lifespan of the secondary battery.

Furthermore, when the separator configured such that the substrate layer is provided as the outermost layer is used, shrinking or wrinkling of the separator can be drastically reduced in a battery fabrication process and separation of the substrate layer and the nanofiber layer due to different melting temperatures can be prevented.

### BRIEF DESCRIPTION OF DRAWINGS

FIG. 1 is a cross-sectional view illustrating a separator according to an embodiment of the present invention;

FIG. 2 is a cross-sectional view illustrating a separator according to another embodiment of the present invention; and

FIG. 3 is a cross-sectional view illustrating a separator according to a further embodiment of the present invention.

### DETAILED DESCRIPTION OF THE INVENTION

Hereinafter, a detailed description will be given of a separator having an inverted structure for a secondary battery according to preferred embodiments of the present invention.

Unless otherwise defined, all the technical terms used herein have the following definitions and correspond to the meanings as generally understood by those skilled in the art. Also, preferred methods or samples are described herein, but those similar or equivalent thereto are incorporated in the scope of the invention. The contents of all the publications disclosed as references herein are incorporated in the present invention.

The term “about” means the amount, level, value, number, frequency, percent, dimension, size, quantity, weight or length changed by 30, 25, 20, 15, 10, 9, 8, 7, 6, 5, 4, 3, 2 or 1% relative to the referred amount, level, value, number, frequency, percent, dimension, size, quantity, weight or length.

Throughout the description, unless otherwise stated, the term “comprises or includes” and/or “comprising or including” used herein shall be construed as indicating the presence of steps or elements described herein, or the group of steps or elements, but should be understood so as not to exclude presence or additional probability of any other steps or elements, or the group of steps or elements.

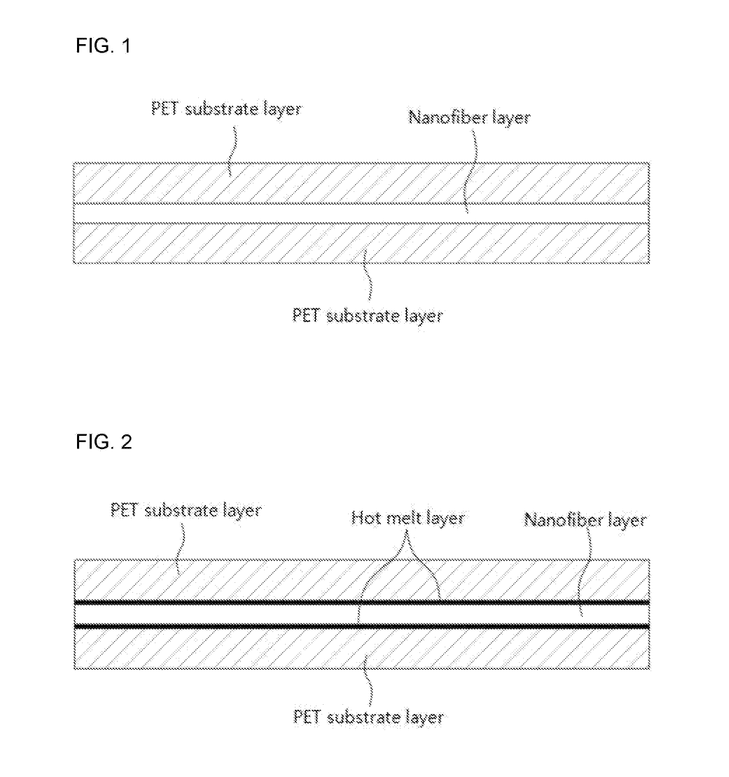

FIG. 1 illustrates a hybrid nonwoven separator having an inverted structure according to an embodiment of the present invention.

Unlike a conventional separator, the separator of FIG. 1 is configured such that a substrate layer is attached to both surfaces of a nanofiber layer, and the substrate layer is provided as the outermost layer of the separator.

The nanofibers of the nanofiber layer are composed of a material from the group consisting of polyimide (PI), aramid, polyvinylidenefluoride (PVDF), polytetrafluoroethylene (PTFE), polychlorotrifluoroethylene (PCTFC), polyvinylidenefluoride-hexafluoropropylene (PVDF-HFP) and mixtures thereof, and the substrate layer comprises PET which is a material for a nonwoven fabric.

Typical materials for a separator for a secondary battery include polyethylene (PE), polypropylene (PP), etc., but the substrate layer of the invention is formed of PET having a high heat resistance temperature and superior affinity to an electrolyte and chemical resistance.

Unlike a conventional separator, the separator of the present invention includes the PET substrate layer as the outermost layer. The PET substrate layer has a coefficient of friction which is about ⅓˜¼ of the coefficient of friction of the nanofiber layer. Hence, when the mandrel is removed from the structure in which the separator is interposed between the cathode plate and the anode plate and wound together while coming into close contact with each other, removal of the separator along with the mandrel may be considerably reduced because of low interfacial friction with the separator, thus minimizing structural deformation upon fabrication of a secondary battery.

Also, the separator of the present invention is configured such that the PET substrate layer is provided as the outermost layer of the separator, and thus the substrate layer may pre-filter electrochemical byproducts or impurities generated upon charging/discharging of the secondary battery. If the nanofiber layer is formed on both surfaces of the substrate layer as in the conventional separator, such byproducts may close the pores of the nanofiber layer, making it impossible to execute the function of the separator as a lithium ion conduction path. However, when the substrate layer having pores ones to tens of times larger than the nanofiber layer is disposed as the outermost layer in a state of the nanofiber layer being interposed as in the present invention, electrochemical byproducts or impurities generated upon charging/discharging of a battery may be first filtered by the substrate layer (even when pores of the substrate layer are closed by impurities, the substrate layer having very large pores make it possible to move a desired material to the nanofiber layer through the other pores). As only the material passed through the substrate layer may move to the nanofiber layer, problems such as short lifespan of the secondary battery or displacement of ions due to closure of the pores of the nanofiber layer may be prevented.

FIG. 2 illustrates the basic separator structure of FIG. 1 further including a hot melt layer formed at the interface between the nanofiber layer and the substrate layer.

The hot melt layer plays a role in adhering the nanofiber layer having a separator function to the substrate layer as a strength support layer, and is formed by way of electrospinning.

The hot melt layer is another nanofiber layer and has a lower melting temperature compared to the above functional nanofibers and the PET substrate.

In this embodiment, a series of processes, including preparing two substrate layers, electrospinning nanofibers for a hot melt layer on one surface of each of the substrate layers, adhering such substrate layers to both surfaces of a nanofiber layer, applying heat and pressure so that only the hot melt layer is selectively melted to complete layer attachment, are performed, but this process sequence is not necessarily limited thereto, and a specific process sequence for forming the above structure may be changed without limit.

There may be considered some cases where the functional nanofiber layer or the substrate layer is formed of an adhesive material or where heat and pressure are applied so that the nanofiber layer or the substrate layer is partially melted. However, in the case where the nanofiber layer or the substrate layer is formed of an adhesive material, minimum adhesive strength necessary during or after battery fabrication cannot be exhibited, undesirably separating the substrate layer and the nanofiber layer from each other. Also, in the case where the nanofiber layer or the substrate layer is partially melted and attached, melting may occur not only at the interface between the nanofiber layer and the substrate layer but also at the inside of the nanofiber layer and the substrate layer. If so, the pores of the nanofiber layer or the substrate layer may be closed and thus movement of lithium ions becomes difficult, undesirably deteriorating the function of the separator.

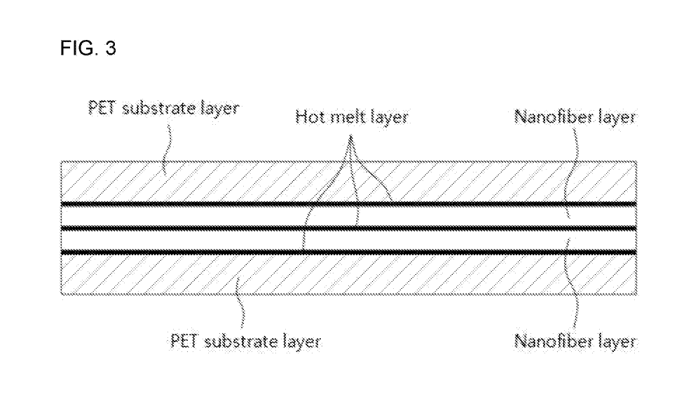

FIG. 3 illustrates the structure wherein the functional nanofiber layer of the separator structure of FIG. 1 is provided in a double layer structure.

The separator of FIG. 3 includes the hot melt layer formed at the interface between the nanofiber layer and the substrate layer and the interface between the nanofiber layers.

In this case, because the substrate layer and the nanofiber layer performing respective functions are maintained unchanged without being melted and the hot melt layer for only layer attachment is formed, tangling due to melting does not occur in the nanofiber layer and the substrate layer and thus pores are not closed.

When the nanofiber layer is provided in a multilayered form in this way, defects which may exist in the nanofiber layer may be compensated for, thus ensuring uniform distribution, compared to a monolayer form.

The PET substrate layer of the separator having an inverted structure for a secondary battery according to the present invention is described below.

The PET nonwoven fabric which constitutes the substrate layer according to the present invention is superior in mechanical strength including tensile strength, punching strength, etc., and has high air permeability and good affinity to an electrolyte. Accordingly, wettability of the separator to an electrolyte may be improved, and the electrolyte filing time may be saved, and the separator may be uniformly filled with the electrolyte. Below, the term ‘PET nonwoven fabric’ or ‘PET substrate layer’ is used as the equivalent meaning.

In the present invention, the PET nonwoven fabric indicates a nonwoven fabric made of PET resin, but may include a PET copolymer or other additives, as well as the nonwoven fabric composed exclusively of PET resin.

The repeating unit of the PET resin, for example, ethyleneterephthalate may be formed by condensation of terephthalic acid or dimethylterephthalate and ethyleneglycol, butyleneterephthalate may be formed by condensation of terephthalic acid or dimethylterephthalate and tetramethyleneglycol, ethylenenaphthalate may be formed by condensation of 2,6-naphthalenedicarboxylic acid or dimethyl-2,6-naphthalenedicarboxylate and ethyleneglycol, and butylenenaphthalate may be formed by condensation of 2,6-naphthalenedicarboxylic acid or dimethyl-2,6-naphthalenedicarboxylate and tetramethyleneglycol.

In some cases, the PET resin may contain a third copolymerization component in an amount of less than 30 wt % of the repeating unit. The monomer useful for the copolymerization component may include, but is not limited to, dibasic or polybasic acids, such as isophthalic acid, dimethyl-2,5-naphthalenedicarboxylate, 2,5-naphthalenedicarboxylic acid, cyclohexanedicarboxylic acid, diphenoxyethanedicarboxylic acid, diphenyldicarboxylic acid, diphenyletherdicarboxylic acid, anthracenedicarboxylic acid or α,β-bis(2-chlorophenoxy)ethane-4,4-dicarboxylic acid, adipic acid, 5-sodium sulfoisophthalic acid, trimellitic acid, pyromellitic acid, etc., diols such as trimethyleneglycol, pentamethyleneglycol, hexamethyleneglycol, hexyleneglycol, neopentyleneglycol, polyethyleneglycol, p-xyleneglycol, 1,4-cyclohexanedimethanol, 5-sodium sulforesorcinol, etc.

For example, the PET nonwoven fabric includes two kinds of PETs having different melting temperatures. Specifically, it comprises ‘first PET fibers’ composed of PET having a melting temperature of 240° C. or more and ‘second PET fibers’ composed of PET having a binder function at 100˜150° C.

The first PET fibers are PET fibers having high heat resistance with high melting temperature, and have superior thermal stability. Thus, the PET nonwoven fabric of the present invention has superior dimensional stability and durability and may greatly improve stability of a secondary battery because of an increased short-circuit temperature. Accordingly, it may exhibit significant effects when applied to large-capacity batteries for ESS, electric vehicles, etc. Below, the first PET fibers may be referred to ‘heat-resistant fibers,’ as necessary.

The second PET fibers are PET fibers having a comparatively low melting temperature and function as binding fibers, and play a role in binding the first PET fibers to each other and the first PET fibers to the second PET fibers upon heat pressing in the course of preparation of the nonwoven fabric. Binding treatment is implemented using the same PET material without the use of an additional adhesive resin, thereby obtaining a nonwoven fabric having superior mutual adhesion and high electrolyte wettability. Below, the second PET fibers may be referred to ‘binding fibers,’ as necessary.

In particular, binding of the second PET fibers of the invention to the first PET fibers in the drying process during the preparation of the nonwoven fabric is effective. Taking into consideration the drying temperature of 100˜150° C., it is important that they perform a function as binding fibers in the above temperature range.

The amount ratio of the heat-resistant first PET fibers and the binding second PET fibers is not particularly limited. If the amount of the heat-resistant fibers is too high, the amount of the binding fibers is comparatively lowered, and thus binding force between the fibers becomes insufficient, undesirably causing separation of the fibers during the fabrication of the battery.

In contrast, if the amount of the binding fibers is too high, the amount of fibers which are tangled with each other in the course of preparation of the nonwoven fabric may increase, making it impossible to achieve a desired porosity.

Therefore, in a preferred embodiment, the amount ratio of the first PET fibers and the second PET fibers is 30:70˜70:30 when the total weight of the substrate layer is 100.

In the present invention, the diameter of the heat-resistant first PET fibers is not particularly limited, but as the diameter thereof is thinned to the extent of nano size, the pore size may become fine, and thus such fibers may be favorably applied to a separator for a secondary battery. If the diameter thereof is less than 6.0 μm, the preparation cost may increase and tangling between the fine fibers may occur.

In contrast, as the diameter of the first PET fibers increases, the preparation process is easy and comparatively simple, but mechanical strength may decrease. If the diameter thereof exceeds 3.0 μm, the pore size of the prepared nonwoven fabric is excessively increased, and thus mechanical strength as the separator cannot be exhibited. Hence, the first PET fibers according to the present invention include fine fibers and micro-sized fibers, with a diameter ranging from about 0.6 μm to less than 3.0 μm.

Accordingly, a fine pore size may be ensured, and low preparation cost may be attained and tangling of fibers may be prevented.

Also, the second PET fibers as the binding fibers, which function as a binder in the above drying temperature, are advantageous because air permeability may increase in proportion to an increase in the cross-sectional diameter thereof. However, if the diameter thereof exceeds 6.0 μm, punching strength may decrease. In contrast, as the diameter thereof decreases, strength may favorably increase. However, if the diameter thereof is less than 1.2 μm, air permeability becomes too low. Hence, the diameter of the fibers is considered to be an important factor, in addition to the binding properties.

The first PET fibers and the second PET fibers preferably have an aspect ratio of about 500˜2000. If the aspect ratio is less than about 500, the fibers are short and thus mechanical strength of the fibers may become very low. In contrast, if the aspect ratio exceeds about 2000, dispersibility of the fibers is remarkably decreased, unfavorably increasing non-uniformity of products and tangling of fibers, and the fibers thus tangled are regarded as appearance impurities, undesirably deteriorating quality of products.

As mentioned above, the PET substrate according to the embodiment of the present invention includes two kinds of PET fibers having different melting temperatures, wherein respective kinds of fibers have two types of fibers having different cross-sectional diameters, that is, thicknesses, thereby making it possible to form a thin film required in the art despite the use of a PET material, with a high porosity of 45˜85% and a fine pore diameter of 0.5˜7.0 μm and uniform porosity distribution.

The PET nonwoven fabric according to the present invention exhibits superior mechanical strength, for example, a tensile strength of 250˜1500 kgf/cm² and a punching strength of 200˜900 gf.

Also, the PET substrate layer may be provided in the form of a monolayer structure, or a multilayer structure having two or more layers. In the monolayer or multilayer structure, the total thickness is preferably set to about 10˜50 μm.

### Preparative Examples 1 to 7

Samples having a final thickness of 8 μm were manufactured using first PET fibers (Kuraray, Kolon) having a melting temperature of 240° C. or more with a diameter of 1.5 μm and second PET fibers (Kuraray, Kolon) having a binder function at 100˜150° C. with a diameter of 1.5 μm at different weight ratios as shown in Table 1 below.

1-1. A sample prepared in a beaker was placed in a laboratory handsheet machine. The sample was composed of first fibers and second fibers in different amounts of wt % with the same concentration selected from the range of 0.01˜0.1 wt % relative to water so as to achieve high dispersibility.

1-2. The sample placed in the handsheet machine was stirred at a high rate of 3600 rpm for 1 min using a blade type stirrer so that PET fibers were efficiently dispersed. If the stirring time is too long, PET fibers are tangled with each other and thus less dispersed, and after fabrication of the sample, the fibers thus tangled are regarded as impurities and thus quality may deteriorate.

1-3. The uniformly dispersed material was placed on a wire mesh so as to be naturally dewatered for a predetermined period of time.

1-4. After primary natural dewatering, the sample was wrapped in a fine blanket and passed through a roll dryer at 115° C., and thus secondary dewatering was carried out.

1-5. After secondary dewatering, the sample was worked at a predetermined temperature under predetermined pressure using a heat calendering machine in the temperature range from 180° C. to less than 240° C., and each sample was evaluated.

TABLE 1

| | 1^{st} Fibers wt % | 2^{nd} Fibers wt % | Note |
|---|---|---|---|
| Prep. Ex. 1 | 20 | 80 | 8 μm Thick. |
| Prep. Ex. 2 | 30 | 70 | 8 μm Thick. |
| Prep. Ex. 3 | 40 | 60 | 8 μm Thick. |
| Prep. Ex. 4 | 50 | 50 | 8 μm Thick. |
| Prep. Ex. 5 | 60 | 40 | 8 μm Thick. |
| Prep. Ex. 6 | 70 | 30 | 8 μm Thick. |
| Prep. Ex. 7 | 80 | 20 | 8 μm Thick. |

<Evaluation Method>

1. Punching Strength

To measure punching strength, a sample is spread and fixed to a test frame. The fixed sample is applied to a needle having a diameter of 1 mm under a force of 1 kgf until it is punched. The value when the sample is punched is recorded in the unit of gf. Ten measurements per sample are performed and the average value is determined.

2. Tensile Strength

A sample is cut to a length of 10 cm and a width of 1 cm in MD and TD, and then fixed to the top and bottom of a tensile strength meter with clips. The tensile strength is measured at a speed of 500 mm/min. The strength when the sample is broken under a force applied in the top and bottom directions is represented as tensile strength. Five measurements per sample are performed and the average value is determined. The unit is kgf/cm².

3. Thermal Stability

Three samples having a size of 140 mm×60 mm are prepared and crosslines are drawn at 100 mm in a length direction and 40 mm in a width direction. The test temperature is set, and when an oven reaches the set temperature and thus is maintained in temperature, the sample is placed in the oven and allowed to stand for 60 min, taken out of the oven and then allowed to stand at room temperature for 10 min. The decreased length of the crosslines compared to the length of the crosslines before testing is measured, and a thermal shrinkage is calculated.

Thermal shrinkage(%): (initial length−length after oven testing)/initial length×100

4. Maximum Pore Size

A pore size is measured using a porometer. A sample is cut to a size of 30 mm×30 mm and then fixed to a porometer, and results of the sample in a dry state and a wet state using a standard solution are calculated by means of differential/integral calculus, thus determining the average pore size, maximum pore size and pore distribution of the sample.

5. Uptake (%)

A separator sample is cut to a width of 5 cm and a length of cm and then immersed in an electrolyte for 5 min, and the remaining electrolyte is removed from the surface thereof, and the weight of the separator is measured.

Uptake(%)=(total weight after immersion in electrolyte−weight of sample)/(weight of sample)×100

### Test Example 1

Products having a total thickness of 20 μm comprising PET outermost layers (8 μm×2) 16 μm thick using respective PET nonwoven fabrics of Preparative Examples 1 to 7 and PVDF nanofiber layers (1.5 μm×2) 3 μm thick and a hot melt layer 1 μm thick between the PET nonwoven fabrics, and a commercially available separator (Celgard® 2320) from Celgard, USA, were measured for air permeability, punching strength, tensile strength and thermal stability. The results are shown in Table 2 below.

TABLE 2

| | | | Tensile | | Thermal stability | | | | | |
|---|---|---|---|---|---|---|---|---|---|---|
| | Air | Punching | strength | | (shrinkage %) | | | | | |
| | permeability | strength | kgf/cm² | | 95° C. | | 125° C. | | 150° C. | |
| | cm³/cm²/s | gf | MD | TD | MD | TD | MD | TD | MD | TD |
| Prep. Ex. 1 | 0.2 | 330 | 440 | 350 | 0 | 0 | 0 | 0 | 0 | 0 |
| Prep. Ex. 2 | 1.0 | 415 | 630 | 510 | 0 | 0 | 0 | 0 | 0 | 0 |
| Prep. Ex. 3 | 1.3 | 425 | 770 | 603 | 0 | 0 | 0 | 0 | 0 | 0 |
| Prep. Ex. 4 | 1.5 | 430 | 820 | 690 | 0 | 0 | 0 | 0 | 0 | 0 |
| Prep. Ex. 5 | 1.7 | 427 | 780 | 614 | 0 | 0 | 0 | 0 | 0 | 0 |
| Prep. Ex. 6 | 1.9 | 380 | 610 | 470 | 0 | 0 | 0 | 0 | 0 | 0 |
| Prep. Ex. 7 | 2.8 | 290 | 420 | 330 | 0 | 0 | 0 | 0 | 0 | 0 |
| Celgard | 0.07 | 360 | 2000 | 150 | 5 | 0 | 38 | 19 | 56 | 32 |
| Separator | | | | | | | | | | |
| (20 μm) | | | | | | | | | | |

As is apparent from the above results, Preparative Example 1 exhibited comparatively higher air permeability and thermal stability but inferior mechanical strength including punching strength and tensile strength, compared to the conventional Celgard separator.

Thus, Preparative Examples 2 to 6 are vastly superior in chemical and mechanical properties to the extent of exceeding critical levels, compared to the other comparative examples, and may thus be efficiently used as the separator.

Below is a description of the hot melt layer formed at the interface between the nanofiber layer and/or the substrate layer.

The material for the hot melt layer is not particularly limited so long as it has ionic conductivity and does not adversely affect the battery performance, and is preferably selected from among urea, melamine, phenol, unsaturated polyester, polypropylene, epoxy, resorcinol, vinylacetate, polyvinylalcohol, vinylchloride, polyvinylacetal, acryl, saturated polyester, polyamide, polyethylene, butadiene rubber, nitrile rubber, butyl rubber, silicone rubber, vinyl, phenol-chloroprene rubber, polyamide, and rubber-epoxy, or may be selected from among mixtures of two or more thereof, copolymers, graft copolymers, and compound materials through general chemical modification. More preferably, the above material is selected from the group consisting of polypropylene, ethylenevinylacetate and butadiene rubber.

Taking into consideration the battery performance, the hot melt layer preferably has a low thickness and a high porosity. For example, the thickness of the hot melt layer is about 0.2˜30% of that of the PET nonwoven substrate layer, and is specifically about 0.1˜3.0 μm. This layer may be provided in the form of a monolayer or a multilayer.

The hot melt layer of the invention has low electric resistance, and may thus prevent the performance of a secondary battery from deteriorating when applied to such a battery. If the thickness thereof is less than 0.1 μm, adhesive strength may become weak, thus easily separating the nanofiber layer and/or the substrate layer. In contrast, if the thickness thereof exceeds 3.0 μm, air permeability and porosity may decrease due to the thick hot melt layer, undesirably deteriorating the performance of the separator.

In an embodiment of the present invention, the hot melt layer composed of nanofibers was formed on the PET substrate layer using an electrospinning process. The electrospinning process is not particularly limited, and may be modified so as to be adapted for the present invention based on the manner known in the art.

For example, the electrospinning process may include the steps of applying a voltage to prepare an electrically charged spinning solution, extruding the charged spinning solution through a spinning nozzle to give nanofibers, and integrating the nanofibers on a collector having the charge opposite to that of the spinning solution. The electrospinning process is advantageous in terms of easy formation of fibers having a nano-size diameter.

In an embodiment, the hot melt layer preferably comprises nanofibers having an average diameter of about 50˜1500 nm. If the average diameter of the nanofibers is less than about 50 nm, air permeability of the separator may decrease. In contrast, if the average diameter thereof exceeds about 1500 nm, it is not easy to adjust the pore size and the thickness of the separator.

1. A hybrid nonwoven separator having an inverted structure, comprising:
a nanofiber layer; and
a substrate layer comprising a nonwoven fabric provided on both surfaces of the nanofiber layer to form an outermost layer.

2. The hybrid nonwoven separator of claim 1, wherein the nanofiber layer comprises nanofibers composed of a material selected from the group consisting of polyimide (PI), aramid, polyvinylidenefluoride (PVDF), polytetrafluoroethylene (PTFE), polychlorotrifluoroethylene (PCTFC), polyvinylidenefluoride-hexafluoropropylene (PVDF-HFP) and mixtures thereof, and the substrate layer comprises polyethyleneterephthalate (PET).

3. The hybrid nonwoven separator of claim 2, wherein a hot melt layer comprising melted nanofibers for layer attachment is further provided at an interface between the nanofiber layer and the substrate layer.

4. The hybrid nonwoven separator of claim 3, wherein the nanofiber layer is provided in a multilayered form, and the hot melt layer comprising melted nanofibers for layer attachment is further provided at an interface of the multilayered nanofiber layer.

5. The hybrid nonwoven separator of claim 1, wherein the substrate layer comprises two kinds of PET fibers having different melting temperatures, comprising first PET fibers composed of PET having a melting temperature of 240° C. or more and a diameter ranging from 0.6 μm to less than 3.0 μm and second PET fibers composed of PET having a binder function at 100˜150° C. and a diameter ranging from 1.2 μm to less than 6.0 μm.

6. The hybrid nonwoven separator of claim 5, wherein the first PET fibers and the second PET fibers have an aspect ratio of 500˜2000.
